(19) United States
(12) Patent Application Publication
(10) Pub. No.: US 2026/0277941 A1
(43) Pub. Date: Sep. 17, 2026

(54) ENHANCEMENT OF RETRIEVAL AUGMENTED GENERATION USING GEOSPATIAL DATA

(71) Applicant: Chevron U.S.A. Inc., San Ramon, CA (US)

(72) Inventors: James Geoffrey Price, Houstion, TX (US); Laura Leigh Bandura, Houston, TX (US); Hilario Lumbreras, III, Sugar Land, TX (US); Tomas Enrique Fernandez, San Francisco, CA (US)

(21) Appl. No.: 19/076,894

(22) Filed: Mar. 11, 2025

(51) Int. Cl. G06F 16/29; G06F 16/22; G06F 16/3329; G06F 16/335

(52) U.S. Cl. CPC G06F 16/29; G06F 16/22; G06F 16/3329; G06F 16/335

(57) ABSTRACT

Queries from users are analyzed to determine whether the queries are geospatial in nature. For geospatial queries, a geospatial agent accesses a geographic information system database to locate geospatial records to provide geospatial awareness to generative artificial intelligence. The located geospatial records are provided to generative artificial intelligence for use as context in generating responses to the geospatial queries.

### FIELD

The present disclosure relates generally to the field of enhancing retrieval augmented generation using geospatial data.

### BACKGROUND

Generative artificial intelligence may be used to generate content, such as responses to information requests or questions. Generative artificial intelligence may generate responses to requests/questions using information sources fed to it. Lack of spatial awareness by generative artificial intelligence may result in incomplete or inaccurate responses being generated for geospatial requests/questions.

### SUMMARY

This disclosure relates to enhancing retrieval augmented generation using geospatial data. A natural language query from a user may be obtained. Whether the natural language query includes a geospatial query may be determined. Responsive to determination that the natural language query includes the geospatial query, the geospatial query may be processed using a geospatial agent. The geospatial agent may access a geographic information system database to locate one or more geospatial records for the geospatial query. The geospatial record(s) may be located for the geospatial query to provide geospatial awareness to a large language model to answer the natural language query. The geospatial record(s) located by the geospatial agent may be provided to the large language model as context to answer the natural language query. The geospatial record(s) located by the geospatial agent may provide geospatial awareness to the large language model to answer the natural language query. The large language model generates a response to the natural language query. The response may be output to the user.

A system for enhancing retrieval augmented generation using geospatial data may include one or more electronic storage, one or more processors and/or other components. The electronic storage may store information relating to natural language queries, information relating to geospatial queries, information relating to a geospatial agent, information relating to a large language model, information relating to a geographic information system database, information relating to geospatial records, and/or other information.

The processor(s) may be configured by machine-readable instructions.

Executing the machine-readable instructions may cause the processor(s) to facilitate enhancing retrieval augmented generation using geospatial data. The machine-readable instructions may include one or more computer program components. The computer program components may include one or more of a natural language query component, a geospatial query component, a geospatial agent component, a large language model component, an output component, and/or other computer program components.

The natural language query component may be configured to obtain one or more natural language queries. The natural language quer(ies) may be obtained from one or more users.

The geospatial query component may be configured to determine whether a natural language query includes a geospatial query.

The geospatial agent component may be configured to, responsive to determination that a natural language query includes a geospatial query, process the geospatial query using a geospatial agent. The geospatial agent may access one or more geographic information system databases to locate one or more geospatial records for the geospatial query. The geospatial record(s) may be located for the geospatial query to provide geospatial awareness to one or more large language models to answer the natural language query.

In some implementations, one or more maps may be generated for the geospatial record(s) located by the geospatial agent.

In some implementations, the geospatial agent may convert a geospatial query into one or more operations. In some implementations, conversion of a geospatial query into one or more operations may include selection from among existing spatial operations. In some implementations, the existing spatial operations may include proximity, intersection, buffer, overlay, spatial join, and/or interpolation. In some implementations, conversion of a geospatial query into one or more operations may include creation of one or more new spatial operations.

In some implementations, a geographic information system database may include structured data and/or other types of data. In some implementations, one or more searches may be performed on unstructured data based on the geospatial record(s) located by the geospatial agent to locate one or more unstructured records for the natural language query. In some implementations, the unstructured record(s) may include analog data, legacy interpretation, reports, and/or other types of records.

The large language model component may be configured to provide the geospatial record(s) located by the geospatial agent to the large language model(s). The geospatial record(s) may be provided to the large language model(s) as context to answer the natural language query. The geospatial record(s) located by the geospatial agent may provide geospatial awareness to the large language model(s) to answer the natural language query. The large language model may generate one or more responses to the natural language query.

In some implementations, the unstructured record(s) located from search(es) on the unstructured data may be provided to the large language model as additional context to answer the natural language query.

The output component may be configured to output the response(s) to the user(s). In some implementations, the geospatial record(s) located by the geospatial agent may be saved as context for one or more follow up natural language queries. In some implementations, the response(s) generated by the large language model(s) may be saved as additional context for one or more follow up natural language queries.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for enhancing retrieval augmented generation using geospatial data.

FIG. 2 illustrates an example method for enhancing retrieval augmented generation using geospatial data.

FIG. 3 illustrates an example process for enhancing retrieval augmented generation using geospatial data.

FIG. 4 illustrates an example agentic framework for enhancing retrieval augmented generation using geospatial data.

FIG. 5 illustrates an example component diagram for enhancing retrieval augmented generation using geospatial data.

### DETAILED DESCRIPTION

The present disclosure relates to enhancing retrieval augmented generation using geospatial data. Queries from users are analyzed to determine whether the queries are geospatial in nature. For geospatial queries, a geospatial agent accesses a geographic information system database to locate geospatial records to provide geospatial awareness to generative artificial intelligence. The located geospatial records are provided to generative artificial intelligence for use as context in generating responses to the geospatial queries.

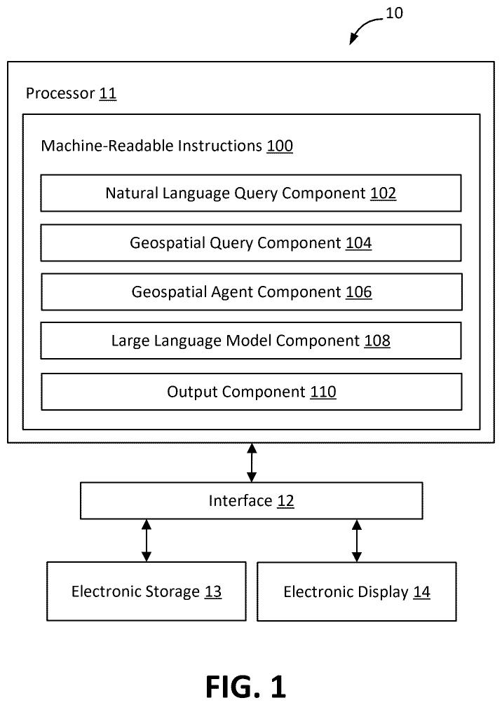

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. A natural language query from a user may be obtained by the processor 11. Whether the natural language query includes a geospatial query may be determined by the processor 11.

Responsive to determination that the natural language query includes the geospatial query, the geospatial query may be processed by the processor 11 using a geospatial agent. The geospatial agent may access a geographic information system database to locate one or more geospatial records for the geospatial query. The geospatial record(s) may be located for the geospatial query to provide geospatial awareness to a large language model to answer the natural language query. The geospatial record(s) located by the geospatial agent may be provided by the processor 11 to the large language model as context to answer the natural language query. The geospatial record(s) located by the geospatial agent may provide geospatial awareness to the large language model to answer the natural language query. The large language model may generate a response to the natural language query. The response may be output by the processor 11 to the user.

The electronic storage 13 may include one or more electronic storage media configured to electronically store information. The electronic storage 13 may include one or more non-transitory storage media. The electronic storage 13 may store software algorithms, information determined by the processor 11, information received remotely, and/or other information that enables the system 10 to function properly. For example, the electronic storage 13 may store information relating to natural language queries, information relating to geospatial queries, information relating to a geospatial agent, information relating to a large language model, information relating to a geographic information system database, information relating to geospatial records, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to natural language queries, information relating to geospatial queries, information relating to a geospatial agent, information relating to a large language model, information relating to a geographic information system database, information relating to geospatial records, and/or other information.

Retrieval Augmented Generation (RAG) may be used to enhance the accuracy and reliability of generative Al models with information drawn from specified sources. However, RAG solutions are only as accurate/reliable as the information sources they are fed. Conventional RAGs retrieve information and generate insights from textual information in documents. However, queries relating to subsurface regions have either an implicit or explicit spatial context and dependence that RAG is aware of only if it is stated within the source documents.

The efficacy of RAG is tied to the quality and relevance of the data fed to a large language model (LLM). Geospatial (location-based) queries present unique challenges for a RAG system, with the responses generated by LLM being highly susceptible to hallucinations due to the complexity and nuance of spatial data structures that are not explicitly represented in the data sourced by the base LLM, nor within the additional context provided by the RAG system. As such, a seemingly straightforward query may require spatial operations capabilities (geoprocessing) such as proximity and intersection.

For example, a query such as “return all seismic surveys within ten miles of location (x)” will result in the LLM generating an incomplete or incorrect answer unless the source data explicitly includes the location question and answer. Such spatial problem-solving typically requires specialized expertise and geographic information system (GIS) software, which can handle object geometry abstractions, topological relationships, coordinate reference systems (CRS), and specialized methods for spatial data manipulation (e.g., proximity, intersection, buffer, overlay, spatial join, interpolation).

The present disclosure provides a tool to enhance subsurface RAGs with geospatial context and data. For queries that are geospatial in nature, the language capabilities of a LLM are extended by providing additional context in the form of relevant geospatial locations and documents (e.g., well logs, seismic interpretations, technical analyses contained within reports, such as in presentation files, PDFs, image files, word documents, etc.). For a geospatial query, the tool retrieves relevant geospatial records from a GIS database and utilizes the retrieved geospatial records to identify relevant unstructured records from among unstructured data. The tool passes the geospatial records and the unstructured records to a LLM for use as context in generating a response to the query. The response may be in the form of texts, graphs, images, maps, and/or sounds. Other forms of response are contemplated.

The tool of the present disclosure improves the quality of RAG by making it aware of the geospatial context related to the user's query. The tool identifies and sequences relevant spatial data and geoprocessing tool(s) for completing tasks, including by dynamically generating required tools on the fly. The tool interacts with GIS database and execute spatial data tools and operations. The tool enables basic and complex spatial analysis to be performed by users without requiring the users to have specialized GIS knowledge.

The tool accesses GIS database and utilizes spatial geometry to process and analyze geospatial data to identify patterns and trends. The tool passes geospatial records and unstructured records (derived from geospatial records) to RAG for use as context and for use in natural conversational flow to fill in gaps to solve simple to complex geospatial queries. The tool generates visual representations of geospatial information in queries and/or responses, such as in maps, to enable validation of the responses output by the tool. New processes/workflows utilized by the tool are captured and reused for future queries, thus preventing replication of duplicative processes/workflows. The tool enables use of a natural language interface to recognize and solve geospatial problems. The tool enables more efficient data interpretation, decision-making, and collaboration between non-GIS users.

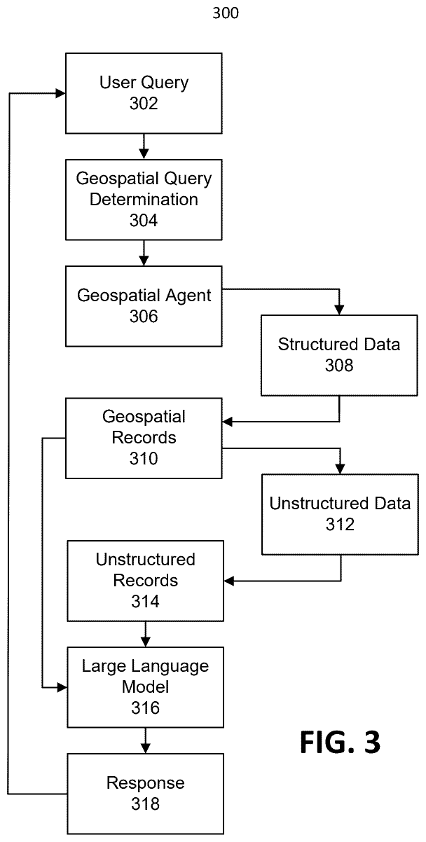

FIG. 3 illustrates an example process 300 for enhancing retrieval augmented generation using geospatial data. The process 300 may begin a user query 302. The user query 302 may be obtained through an interactive interface. For example, the user query 302 may be obtained via user entry of the user query 302 through a texting/chat interface. Use of the interactive interface may enable back and forth interaction with the user (e.g., user entry of initial query, provision of response to the initial query, user entry of follow-up query, provision of response to the follow-up query).

Determination 304 may be made of whether the user query 302 includes a geospatial query. Based on the determination that the user query 302 includes a geospatial query, the user query may be passed to a geospatial agent 306 for processing. The geospatial agent 306 may perform one or more searches on structured data 308 (e.g., GIS database) to locate geospatial records 310 that are relevant to the geospatial query/the user query 302. The geospatial agent 306 may create an array with the geospatial records 310 retrieved from the structured data 308. The structured data 308 may store geospatial information about different things (e.g., well, equipment, pipeline, facility, reservoir, field) in a table, with individual listing of a thing being a geospatial record. Things may include natural/geologic things (e.g., reservoir) and/or cultural things (e.g., road, facilities, pipelines). Things may include a living thing and/or a non-living thing. The geospatial agent 306 may extract and store in the array one or more types of information from the geospatial records 310, such as name, location (e.g., position on Earth, size, volume, width, height, depth), thing type, and/or thing value. The geospatial agent 306 may extract and store in the array information on the geometry of the thing. For example, the geospatial agent 306 may extract and store in the array information on the shape of the thing (e.g., series of points that defines shape of a pipeline).

The geospatial records 310 may be used to perform one or more searches on unstructured data 312 (e.g., collection of unstructured records) to locate unstructured records 314 that are relevant to the geospatial query/the user query 302. The information stored in the array created by the geospatial agent 306 may be used to perform a search on the unstructured data 312 (e.g., geospatial records identify names/identifiers of wells in a region of interest, and the names/identifiers of the wells in the array are used to pull relevant well logs).

The geospatial records 310 may provide spatial awareness to determine which unstructured records 314 are relevant to the user query 302. The geospatial records 310 and/or the unstructured records 314 may be provided to a large language model 316 for use as context in generating a response 318 to the user query 302. A large language model (LLM) may refer to a type of artificial intelligence (Al) that can process, understand, and generate human language. A large language model may refer to a computational model capable of language generation and other natural language processing (e.g., speech recognition, text classification, natural-language understanding) tasks. The analysis of a user query using a large language model may include natural language processing of the user query. Natural language processing may include the use of machine learning models to interpret, manipulate, and/or comprehend human language.

The geospatial records 310 and/or the unstructured records 314 may be stored in a buffer as context to answer the user query 302. The geospatial records 310 and/or the unstructured records 314 may provide geospatial awareness to the large language model 316 to answer the user query 302. Geospatial awareness provided by the geospatial records 310 and/or the unstructured records 314 may allow the large language model 316 to understand spatial relationships between different components/pieces of information. Geospatial awareness provided by the geospatial records 310 and/or the unstructured records 314 may allow the large language model 316 to process generate the response 318 by relating the user query 302 to geospatial information in external data sources. Thus, the information sources provided to the large language model 316 are enhanced via the geospatial agent 306. The geospatial records 310 and/or the unstructured records 314 not only enhance the information available for use by the large language model 316 to generate the response 318 (e.g., greater amount of information, more detailed information), but also enables the large language model 316 to gain understanding of how different things are spatial related/located.

The response 318 may be output to the user. The response 318 may be output through an interactive interface (e.g., a texting/chat interface). The response 318 may be stored in the buffer for use as context in answering the next query. The user may continue the process by inputting the next query. The next query from the user may be related to the prior query/response. For example, the next query may reference one or more parts of the prior query/response. Information stored in the buffer may be retained for use as context in generating the response to the next query. The next query from the user may not be related to the prior query/response. In such a case, the prior response and other information stored in the buffer for generating of the prior response may be cleared from the buffer.

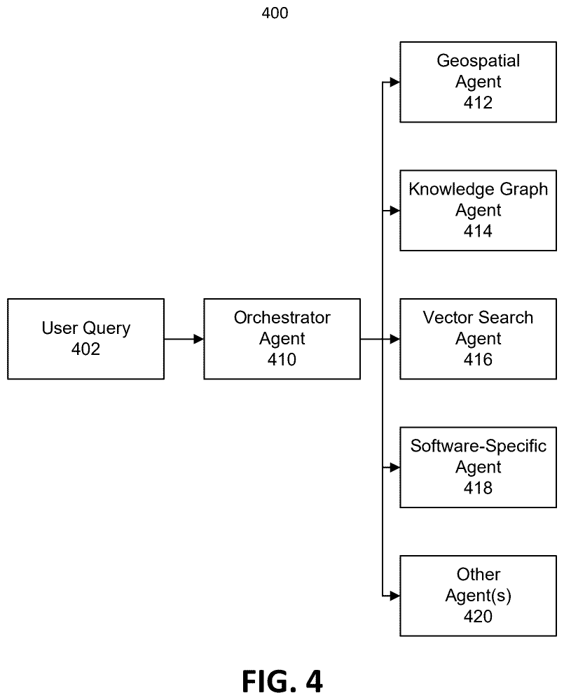

FIG. 4 illustrates an example agentic framework 400 for enhancing retrieval augmented generation using geospatial data. The agentic framework 400 may utilize/call different agents to access/retrieve different information to enhance retrieval augmented generation. The agentic framework 400 may include an orchestrator agent 410, a geospatial agent 412, a knowledge graph agent 414, a vector search agent 416, a software-specific agent 418, and/or other agent(s) 420. An agentic framework may refer to a system architecture in which autonomous agents interact and collaborate to achieve a common goal. Use of the agentic framework 400 may enable complex geospatial questions to be answered without specialized expertise with GIS software/databases. Use of the agentic framework 400 may provide flexibility in answering varieties of geospatial queries.

Agents may refer to software entities that perform specific tasks independently. An agent may include a set of software functionality configured to interact with other agents and/or resources to make decisions and/or achieve an outcome. An agent may orchestrate the utilization of resources, large language models, databases, and/or other entities in order to provide a response to a query. Agents and/or resources may be organized in one or more hierarchies. An agent may may obtain queries (prompts), identify and organize a set of activities to carry out to accomplish what is being prompted (e.g., to provide a response to a query), and/or perform other functionally. An agent may access large language model(s) directly in the execution of the set of activities, and/or through one or more resources organized in the hierarchy. For example, an operation to be carried out by an agent in response to obtaining a query may include the agent prompting one or more other resources (e.g., other agent(s), resource(s), and/or large language model(s) directly) using prompts known by the agent to be effective. Other resource(s) may then identify and organize a set of sub-Client operations known to the other resource(s) to be effective in accomplishing what is being asked by the agent.

Autonomous agents may perform tasks without human supervision. Individual agents may be designed to handle specific types of tasks or queries, making the system modular, scalable, and efficient. Individual agents may have a specific role or specialty, such as searching a database, retrieving knowledge, or processing data. Individual agents may communicate and collaborate with other agents to share information and complete tasks.

A user query 402 may be received by the orchestrator agent 410. The orchestrator agent 410 may orchestrate/coordinate the activities of various agents based on the requirements of the user query 402. The orchestrator agent 410 may determine whether the user query 402 includes a geospatial query. Responsive to determination that the user query 402 includes a geospatial query, the orchestrator agent 410 may pass the user query 402/the geospatial query to the geospatial agent 412.

The geospatial agent 412 may run one or more processes (function(s)) to search a GIS database and retrieve relevant structured data (e.g., geospatial records identifying, characterizing, and/or defining things that match the geospatial query, such as a geospatial record identifying a well/field) from the GIS database. The relevant structured data may identify things that match the geospatial query (e.g., names/identifiers of wells in a region of interest). The geospatial query may be converted into one or more geospatial criteria, and the relevant structured data (geospatial records) that satisfy the geospatial criteria may be retrieved.

With the geospatial records, the unstructured data may be searched to retrieve relevant unstructured data (e.g., unstructured records that provide information about the things that match the geospatial query, such as reports that specify rock properties in the well/field). The geospatial records may be used to determine which of the unstructured data is relevant to the user query 402. Different types of agents may be used to pull different types of unstructured data.

For example, the knowledge graph agent 414 may utilize knowledge graph-based index to retrieve (identify, pull) relevant unstructured data. A knowledge graph may define relationships between entities (e.g., objects, places, concepts) using edges. The nodes/edges may be traversed to identify relevant unstructured data. The vector search agent 416 may utilize vectors/embeddings to retrieve relevant unstructured data. The software-specific agent 418 may interface/communicate with specific software to retrieve relevant unstructured data. For example, a Petrel Studio agent may interface/communicate with Petrel Studio to identify and pull specific types of data (e.g., identify surfaces and interpretations). Other agent(s) 420 may be used to retrieve relevant unstructured data from other sources of information.

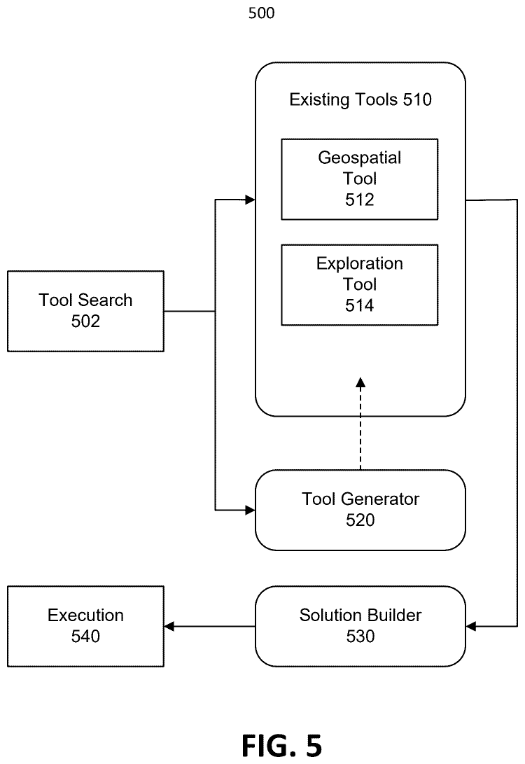

FIG. 5 illustrates an example component diagram 500 for enhancing retrieval augmented generation using geospatial data. A tool search 502 may be performed to determine whether one of the existing tools 510 can be used to solve a spatial problem posed by a user query. For example, the existing tools may include a geospatial tool 512 and an exploration tool 514. The geospatial tool 512 may be capable of performing spatial operations, such as proximity, intersection, buffer, overlay, spatial join, and/or interpolation. The exploration tool 514 may be capable of performing analysis across both unstructured and structured data, such as for risk assessment, volume analysis, and/or analog identification. The exploration tool 514 may be capable of orchestrating exploration related tasks. One or more of the existing tools 510 that can perform functions necessary to solve the spatial problem posed by the user query may be selected for use.

If the existing tools 510 are not capable of performing functions necessary to solve the spatial problem posed by the user query, a tool generator 520 may be used to create and save a new tool. For example, a new spatial operation may be created (e.g., from scratch, by modifying and/or combining existing spatial operations). One or more tools (previously existing tool, newly created tool) may be selected to solve the spatial problem posed by the user query. The selected tool(s) may be provided to a solution builder 530, which may generate code that is needed to be executed to generate a response to the user query. The solution builder 530 may include and/or use a large language model to generate the code. The code may sequence the selected tool(s) for execution. The code generated by the solution builder 530 may be executed 540 to generate a response to the user query.

For example, a user query may be received through a texting/chat interface, with the user inputting: “Show me a map of the producing fields within 20 km buffer the block GB###.” GIS structured data schema may be generated and provided in a system prompt. Prompts for tools to be used may be added. The GIS database may be searched to locate the relevant geospatial records. A large language model may be prompted to generate code solve the user query, with the information to be used as context provided to the large language model in the prompt and/or stored in a buffer. The code may be executed (e.g., in isolated container(s) for security) and the results may be presented to the user in the texting/chat interface.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate enhancing retrieval augmented generation using geospatial data. The machine-readable instructions 100 may include one or more computer program components. The machine-readable instructions 100 may include one or more of a natural language query component 102, a geospatial query component 104, a geospatial agent component 106, a large language model component 108, an output component 110, and/or other computer program components.

The natural language query component 102 may be configured to obtain one or more natural language queries. The natural language quer(ies) may be obtained from one or more users. Obtaining a natural language query may include one or more of accessing, acquiring, analyzing, determining, examining, generating, identifying, loading, locating, measuring, opening, receiving, retrieving, reviewing, selecting, storing, and/or otherwise obtaining the natural language query. Obtaining a natural language query may include obtaining information that characterizes, conveys, defines, describes, identifies, quantifies, and/or reflects the natural language query. In some implementations, a natural language query may be obtained based on user interaction with an interactive interface. For example, the natural language query may be obtained via user entry of the natural language query through a texting/chat interface. In some implementations, obtaining a natural language query may include receiving input from the user and determining that the input includes a query (question).

A natural language query may refer to a question that includes words, phrases, and/or sentences that utilize a language that has developed naturally in use. A natural language query may refer to a query in which words, phrases, and/or sentences are structured according to natural language. A natural language query may include words, phrases, and/or sentences that are structured as if the user is communicating with another person. For example, a natural language query may include words, phrases, and/or sentences that a person would use to request information from another person.

The geospatial query component 104 may be configured to determine whether a natural language query includes a geospatial query. Determining whether a natural language query includes a geospatial query may include ascertaining, establishing, finding, identifying, obtaining, and/or otherwise determining whether or not the natural language query includes a geospatial query. In some implementations, determination of whether a natural language query includes a geospatial query may be performed when the natural language query is obtained. A geospatial query may refer to a location-based query. A geospatial query may refer to a query that includes a question relating to/associated with one or more locations on Earth. A geospatial query may refer to a query where an answer requires information on locations of things on Earth.

Whether a natural language query includes a geospatial query may be determined based on analysis of the natural language query. Query obtained from a user may be monitored to listen for geospatial queries. In some implementations, whether a natural language query includes a geospatial query may be determined based on a comparison of the natural language query with one or more example queries that include geospatial quer(ies). For example, the natural language query may be compared with a query that is known to include a geospatial query to determine similarity between the two queries. A vector/embedding of the natural language query may be compared with a vector/embedding of a query that is known to include a geospatial query to determine cosine similarity between the two queries. Based on the similarity (cosine similarity) being greater than (or equal to) a threshold value, the natural language query may be determined to include a geospatial query. A large language model may be prompted to determine whether a natural language query includes a geospatial query. For example, the large language model may be asked whether or not the natural language query is or includes a geospatial query. The large language model may be asked the probability that the natural language query is or includes a geospatial query. The response generated by the large language model (e.g., yes, no, probability) may be used to determine whether a natural language query includes a geospatial query.

The geospatial agent component 106 may be configured to, responsive to determination that a natural language query includes a geospatial query, process the geospatial query using a geospatial agent. The geospatial query/geospatial aspect of the natural language query may be passed to the geospatial agent for processing. The geospatial agent may access one or more geographic information system databases to locate one or more geospatial records for the geospatial query. The geospatial agent may locate (identify, retrieve, pull) geospatial record(s) that matches the geospatial query.

A geographic information system database may refer to a database that stores geospatial records. A geographic information system database may refer to a database that stores information about locations and attributes/characteristics of things. A geospatial record may refer to a digital record for a thing with a specific location on Earth. A geospatial record may include multiple fields for the thing, such as for name, location, type, and/or value. Whether a geospatial record matches the geospatial query may be determined based on the corresponding location and one or more spatial operations (e.g., e.g., proximity, intersection, buffer, overlay, spatial join, interpolation). The geospatial records/information from the geospatial records may be inserted into an array for use (e.g., as context to answer a natural language query, to find relevant unstructured records). The geospatial records/information from the geospatial records may provide spatial awareness to determine which unstructured records are relevant to the natural language query.

The geospatial record(s) may be located for the geospatial query to provide geospatial awareness to one or more large language models to answer the natural language query. The geospatial record(s)/information from the geospatial records may enable the large language model(s) to understand the spatial relationships between different components/pieces of information.

In some implementations, one or more tools may be used to locate geospatial record(s). For example, a python shell tool may be called. The python shell tool may be preloaded with needed libraries (e.g., GeoPandas), along with data in dataframes (e.g., GeoPandas dataframes) with a preconfigured coordinate reference system. In some implementations, one or more large language models may be used by the geospatial agent. A prompt for a large language model may provide instruction on the use of one or more tools to locate the geospatial records, along with information about the schema of the geospatial data (information on the structure of the geospatial data). For instance, a large language model may be configured to use the python shell tool via the following prompt:
You are an expert at Python and GIS. The [Region Name] GIS layers are available as GeoPandas DataFrames via python. Each GeoPandas Dataframe represents a Layer. Here are the schemas for those GeoPandas DataFrames:
   {geodataframe_schemas}
When a user asks a question that is geospatial in nature, use the python_shell to do any analysis required to answer it.”

A prompt for the tool may provide description of the tool, along with information on how the tool is used. For instance, the following prompt may be used for the python shell tool:
Name: Python_shell
Description: “Use to execute Python code that analyzes the GeoPandas DataFrames. GeoPandas have already been imported using ‘import geopandas as gpd’. Also, these geopandas dataframes have already been preloaded into the REPL. Do not redefine them. Make sure to print any important results.”

In some implementations, one or more maps may be generated for the geospatial record(s) located by the geospatial agent. A map may refer to a diagrammatic representation of one or more parts of the Earth. The map(s) may be generated to show the locations corresponding to the geospatial record(s). The map(s) may show the spatial relationships between the things for which the geospatial records were located. The map(s) may be used to validate that the proper geospatial records were located. The maps enable validation of responses to the user queries.

In some implementations, the geospatial agent may convert a geospatial query into one or more operations. An operation may include a spatial operation. A spatial operation may refer to an operation in which data is processed using spatial aspects of the data. Examples of spatial operations may include proximity, intersection, buffer, overlay, spatial join, interpolation, union, difference, clip, erase, merge, split, and/or dissolve. The spatial operations may be sequenced/ordered for execution. One or more existing spatial operations may be selected to perform the geospatial query. One or more new spatial operations may be created for use. For example, a new spatial operation may be created by combining and/or modifying existing spatial operations. The new spatial operation (e.g., a workflow of existing and/or modified spatial operations) may be saved for reuse to increase performance and consistency in results.

In some implementations, a geographic information system database may include structured data and/or other types of data. Structured data may refer to information organized in a standardized format. Structured data may refer to information organized in one or more tables. The geographic information system database may be searched to locate relevant geospatial records among the structured data.

In some implementations, one or more searches may be performed on unstructured data based on the geospatial record(s) located by the geospatial agent to locate one or more unstructured records for the natural language query. Unstructured data may refer to information that does not have standardized structure or organization. Unstructured data may refer to information that does not have a predefined data model or is not organized in a predefined manner. The unstructured data may be searched to locate relevant unstructured records among the unstructured data. Examples of unstructured record(s) may include analog data, legacy interpretation, reports, and/or other types of records. For instance, based on geospatial records retrieved from structured data, well logs, seismic interpretations, and/or technical analysis for the relevant things (e.g., region of interest, fields, wells) may be retrieved from unstructured data. This may expand the information, such as types and/or level of details of information, available to answer the natural language query. For instance, a natural language query may include a geospatial query that identifies specific wells. The geospatial records for the wells may not include all the details that are included in the well logs for the wells. Unstructured data may be searched using geospatial records to retrieve well logs for the wells to answer the natural language query. Other expansion of information is contemplated.

The large language model component 108 may be configured to provide information to the large language model(s) to enhance the generation of response(s) to the natural language query. The large language model component 108 may be configured to provide the geospatial record(s) located by the geospatial agent to the large language model(s). Information may be provided to a large language model using one or more prompts. A prompt may directly and/or indirectly include the information to enhance the response generation by a large language model. For example, the geospatial record(s)/information contained within the geospatial record(s) may be included in a prompt. The geospatial record(s)/information contained within the geospatial record(s) may be stored within a buffer and presence/use of the information within the buffer may be described in a prompt.

The geospatial record(s) may be provided to the large language model(s) as context to answer the natural language query. Context may include extra information (in addition to information provided through prompts) that may be considered by a large language model in generating a response. The large language model may generate one or more responses to the natural language query, with the response(s) being enhanced in accuracy and/or reliability via use of the information provided as context.

The geospatial record(s) located by the geospatial agent may provide geospatial awareness to the large language model(s) to answer the natural language query. The geospatial record(s) located by the geospatial agent may provide to the large language model(s) information on how different things are located on Earth (e.g., position on Earth, size, volume, width, height, depth). The geospatial record(s) located by the geospatial agent may provide to the large language model(s) information on the relative locations of things on Earth. The geospatial awareness may enable the large language model(s) to better understand and synthesize the natural language queries. The geospatial awareness may enable the large language model(s) to generate responses more accurately and reliably.

In some implementations, the unstructured record(s) located from search(es) on the unstructured data may be provided to the large language model(s) as additional context to answer the natural language query. The unstructured record(s) may provide information that is not included in the geospatial record(s). The unstructured record(s) may provide more detailed and/or precise information that the information included in the geospatial record(s). For example, the geospatial record for a well may provide summary information for the well while the unstructured records for the well may provide detailed information for the well. The unstructured record(s) may enable the large language model(s) to generate more detailed and/or precise response(s) to the natural language queries. The unstructured record(s) may enable the large language model(s) to generate accurate responses without hallucinations.

The output component 110 may be configured to output the response(s) to the natural language quer(ies). The response(s) may be output to the user(s). A response to a natural language query may be output visually, audibly, and/or through other forms. For example, a response to a natural language query may be presented on the electronic display 14 and/or played back over one or more speakers. For instance, a response to a natural language query may be presented within a texting/chat interface through which the natural language query was received.

In some implementations, the geospatial record(s) located by the geospatial agent, the unstructured record(s) located using the geospatial record(s), the response(s) generated by the large language model(s), and/or other information may be saved as context for one or more follow up natural language queries. A follow up natural language query may refer to a natural language query that is obtained (input by a user) after the original/preceding natural language query. The geospatial record(s)/information contained within the geospatial record(s), the unstructured record(s)/information contained within the unstructured record(s), and the responses/information contained within the responses may be stored within a buffer for use in generating a response to a follow up natural language query. This may enable a user to make queries that are related to other/prior queries and/or related to responses from other/prior queries.

In some implementations, the geospatial record(s) and/or the unstructured record(s) used to generate a response to a natural language query may be output to the user(s). For example, the texting/chat interface may present the responses with references to the geospatial record(s) and/or the unstructured record(s), along with a shortcut/link to access the geospatial record(s) and/or the unstructured record(s).

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

As used herein, the phrase “configured to” is intended to be interpreted broadly, as “being capable of or suitable for performing” some function or feature, without requiring any adaptations to provide said function or feature.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

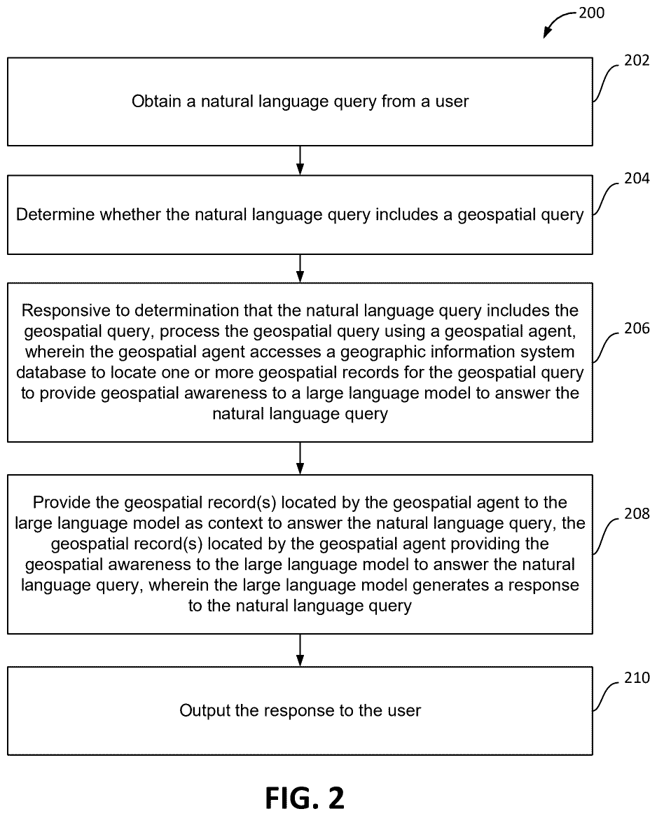

FIG. 2 illustrates method 200 for enhancing retrieval augmented generation using geospatial data. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, a natural language query from a user is obtained. In some implementations, operation 202 may be performed by a processor component the same as or similar to the natural language query component 102 (Shown in FIG. 1 and described herein).

At operation 204, whether the natural language query includes a geospatial query is determined. In some implementations, operation 204 may be performed by a processor component the same as or similar to the geospatial query component 104 (Shown in FIG. 1 and described herein).

At operation 206, responsive to determination that the natural language query includes the geospatial query, the geospatial query is processed using a geospatial agent. The geospatial agent accesses a geographic information system database to locate one or more geospatial records for the geospatial query. The geospatial record(s) are located for the geospatial query to provide geospatial awareness to a large language model to answer the natural language query. In some implementations, operation 206 may be performed by a processor component the same as or similar to the geospatial agent component 106 (Shown in FIG. 1 and described herein).

At operation 208, the geospatial record(s) located by the geospatial agent are provided to the large language model as context to answer the natural language query. The geospatial record(s) located by the geospatial agent provide geospatial awareness to the large language model to answer the natural language query. The large language model generates a response to the natural language query. In some implementations, operation 208 may be performed by a processor component the same as or similar to the large language model component 108 (Shown in FIG. 1 and described herein).

At operation 210, the response is output to the user. In some implementations, operation 210 may be performed by a processor component the same as or similar to the output component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for enhancing retrieval augmented generation using geospatial data, the system comprising:
one or more physical processors configured by machine-readable instructions to:
obtain a natural language query for a subsurface region from a user;
determine whether the natural language query includes a geospatial query;
responsive to determination that the natural language query includes the geospatial query, process the geospatial query using a geospatial agent, wherein the geospatial agent accesses a geographic information system database to locate one or more geospatial records for the geospatial query to provide geospatial awareness to a large language model to answer the natural language query, the one or more geospatial records comprising one or more records on a well, a pipeline, a reservoir, or a field, wherein the geospatial awareness provided by the one or more geospatial records comprises a series of points extracted from the one or more geospatial records that defines shape of the well, the pipeline, the reservoir, or the field, further wherein the geospatial awareness enables determination of which unstructured records relating to the well, the pipeline, the reservoir, or the field are needed to answer the natural language query and enables the large language model to understand absolute or relative spatial relationships of the well, the pipeline, the reservoir, or the field on Earth;
provide the one or more geospatial records located by the geospatial agent to the large language model as context to answer the natural language query and fill gaps in answering the natural language query for the subsurface region, the one or more geospatial records located by the geospatial agent providing the geospatial awareness to the large language model to answer the natural language query, wherein the large language model generates a response to the natural language query; and
output the response to the user.

2. The system of claim 1, wherein:
the geographic information system database includes structured data;
a search is performed on unstructured data based on the one or more geospatial records located by the geospatial agent to locate one or more of the unstructured records for the natural language query; and
the one or more unstructured records are provided to the large language model as additional context to answer the natural language query.

3. The system of claim 2, wherein the one or more unstructured records include analog data, legacy interpretation, and/or reports.

4. The system of claim 1, wherein the one or more geospatial records located by the geospatial agent are saved as context for a follow up natural language query.

5. The system of claim 4, wherein the response generated by the large language model is saved as additional context for the follow up natural language query.

6. The system of claim 1, wherein the geospatial agent converts the geospatial query into one or more operations.

7. The system of claim 6, wherein conversion of the geospatial query into the one or more operations includes selection from among existing spatial operations.

8. The system of claim 7, wherein the existing spatial operations include proximity, intersection, buffer, overlay, spatial join, and/or interpolation.

9. The system of claim 6, wherein conversion of the geospatial query into the one or more operations includes creation of a new spatial operation.

10. The system of claim 1, wherein a map is generated for the one or more geospatial records located by the geospatial agent.

11. A method for enhancing retrieval augmented generation using geospatial data, the method comprising:
obtaining a natural language query for a subsurface region from a user;
determining whether the natural language query includes a geospatial query;
responsive to determination that the natural language query includes the geospatial query, processing the geospatial query using a geospatial agent, wherein the geospatial agent accesses a geographic information system database to locate one or more geospatial records for the geospatial query to provide geospatial awareness to a large language model to answer the natural language query, the one or more geospatial records comprising one or more records on a well, a pipeline, a reservoir, or a field, wherein the geospatial awareness provided by the one or more geospatial records comprises a series of points extracted from the one or more geospatial records that defines shape of the well, the pipeline, the reservoir, or the field, further wherein the geospatial awareness enables determination of which unstructured records relating to the well, the pipeline, the reservoir, or the field are needed to answer the natural language query and enables the large language model to understand absolute or relative spatial relationships of the well, the pipeline, the reservoir, or the field on Earth;
providing the one or more geospatial records located by the geospatial agent to the large language model as context to answer the natural language query and fill gaps in answering the natural language query for the subsurface region, the one or more geospatial records located by the geospatial agent providing the geospatial awareness to the large language model to answer the natural language query, wherein the large language model generates a response to the natural language query; and
outputting the response to the user.

12. The method of claim 11, wherein:
the geographic information system database includes structured data;
a search is performed on unstructured data based on the one or more geospatial records located by the geospatial agent to locate one or more of the unstructured records for the natural language query; and
the one or more unstructured records are provided to the large language model as additional context to answer the natural language query.

13. The method of claim 12, wherein the one or more unstructured records include analog data, legacy interpretation, and/or reports.

14. The method of claim 11, wherein the one or more geospatial records located by the geospatial agent are saved as context for a follow up natural language query.

15. The method of claim 14, wherein the response generated by the large language model is saved as additional context for the follow up natural language query.

16. The method of claim 11, wherein the geospatial agent converts the geospatial query into one or more operations.

17. The method of claim 16, wherein conversion of the geospatial query into the one or more operations includes selection from among existing spatial operations.

18. The method of claim 17, wherein the existing spatial operations include proximity, intersection, buffer, overlay, spatial join, and/or interpolation.

19. The method of claim 16, wherein conversion of the geospatial query into the one or more operations includes creation of a new spatial operation.

20. The method of claim 11, wherein a map is generated for the one or more geospatial records located by the geospatial agent.
